(19) United States
(12) Patent Application Publication
(10) Pub. No.: US 2008/0114561 A1
(43) Pub. Date: May 15, 2008

(54) Method of determining micro- and nano- sizes in scanning electron microscope

(76) Inventors: Dmitriy Yeremin, Dobbs Ferry, NY (US); Arkady Nikitin, Yonkers, NY (US)

Correspondence Address: Ilya Zborovsky, 6 Schoolhouse Way, Dix Hills, NY, 11746, US

(21) Appl. No.: 11/599,556

(22) Filed: Nov. 15, 2006

(51) Int. Cl. G01B 15/00

(52) U.S. Cl. 702/97

(57) ABSTRACT

A method of determining sizes of micro and nano objects in a scanning electron microscope, comprising the steps of obtaining an experimental video signal of an object in a scanning electron microscope, determining a size of an object from the obtained experimental video signal, calculating a model video signal based on the size of an object obtained from the experimental video signal and other values of the object in the scanning electron microscope, determining a size of the object from the model video signal, determining a correction based on a difference between the size of the object obtained from the experimental video signal and the size of the object obtained from the model video signal, and using the correction to determine a corrective size of the object from the size of the object determined from the experimental video signal and the thusly determined correction.

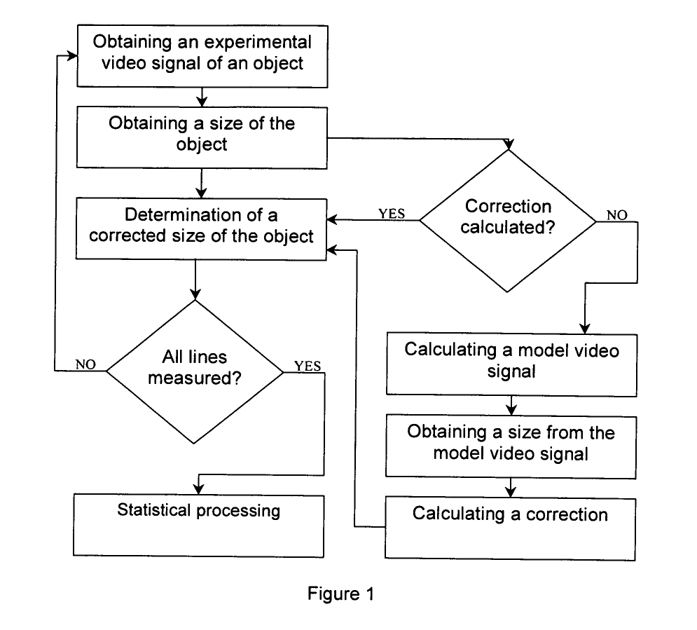

### BACKGROUND OF THE INVENTION

The present invention relates to a method of determining sizes of micro and nano objects in a scanning electron microscope.

The problem of accurate measurements of sizes of micro objects, for example parts of integrated circuits can not be considered as a resolved, despite of efforts of experts over many years, as can be clearly concluded from many publications on this issue. The main reason is that the problem of localization of an edge of a micro object to be measured on its magnified (by means of a corresponding microscope) image is not resolved. The main tool for measurements in a submicron and nanometric range of sizes is a scanning electron microscope. Several algorithms of measurements are proposed and used for localization of the edge on the magnified images in the scanning electron microscope. The known algorithms, include Threshold Algorithm, Line Approximation Algorithm, Derivative Algorithm, Curvature Algorithm, Fermi-Dirac algorithm, etc. [1] However, none of them provides an accurate localization of an edge, since various points of video signals are utilized as the edge of an object to be measured, which are selected in accordance with formal mathematical features, such as for example a preliminarily selected level of signal, a maximum of its derivative, a point of intersection of two straight lines approximating some parts of the video signal, etc. However, they are not connected with a factual position of the edge. Another source of low accuracy of the results is the presence of a so-called free parameters [2] used in the mentioned algorithms. Therefore, it is believed that the known methods make possible obtaining only of approximate, estimating values, and the obtained results need corrections.

### SUMMARY OF THE INVENTION

Accordingly, it is an object of the present invention to provide a method for determining micro and nano sizes of objects, which eliminates the disadvantages of the prior art.

More particularly, it is an object of the present invention to provide a method of determining micro and nano sizes of objects, which provides a high accuracy of measurements.

In keeping with these objects and with others which will become apparent hereinafter, one feature of the present invention resides, briefly stated, in a method of determining sizes of micro and nano objects in a scanning electron microscope, comprising the steps of obtaining an experimental video signal of an object in a scanning electron microscope; determining a size of an object from the obtained experimental video signal; calculating a model video signal based on the size of an object obtained from the experimental video signal and other properties of the object in the scanning electron microscope; determining a size of the object from the model video signal; determining a correction based on a difference between the size of the object obtained from the experimental video signal and the size of the object obtained from the model video signal; and determining a correct size of the object from the size of the object determined from the experimental video signal and the thusly determined correction.

Another feature of the present invention resides, briefly stated, in that the determining the size of a micro and nano object based on the experimental video signal includes orienting the object in the electron microscope so that a selected direction of measurements coincides with a direction of scanning along lines and frames, obtaining a scanning electron microscope image of the micro object in a digital measuring microscope and storing it in a memory of a computer as a two dimensional set of values S depending on coordinates X and Y in a plane of image-S (X, Y), selecting from the stored two-dimensional set of values S (X, Y) a one-dimensional set S(X) reflecting a distribution of the video signal S along the selected direction of measurements; and determining an approximate size of micro object along said direction X: L₀(X) with the use of a known algorithm.

Another feature of the present invention resides, briefly stated, in that the determining a model video signal S_{M}(X) includes using parameters selected from the group consisting of characteristics of an object including coefficients of secondary electron emission for the object and of surroundings of the same, angles of inclination of left and right side walls, presence of neighboring shaped details at a left side and at a right side from the object as well as their height and a distance to them, and an approximate size of the micro object L₀(X), as well as characteristic of the scanning electron microscope including accelerating voltage, resolution or diameter of a beam of primary electrons, a scale of magnification or a distance between neighboring pixels for microscopes with a digital scanning.

Another feature of the present invention resides, briefly stated, in that the determining size of an object from the model video signal includes determining the size of the object Lₘ(X) from the model video signal with the use of an algorithm which is used for determining said approximate size of the micro object based on the experimental video signal.

Another feature of the present invention resides, briefly stated, in that the determining a corrected size of the micro object includes determining based on a formula L=L₀(X)−Δ, wherein Δ=L₀(X)−Lₘ(X)

Another feature of the present invention resides, briefly stated, in repeating said selection of the one-dimensional set, said determination of an approximate size of the micro objects, and said correction for a plurality of lines; and subjecting thusly obtained results to a statistical processing with determination of an average size and dispersion.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing a flowchart of a method of determining micro sizes of objects in accordance with the present invention.

### DESCRIPTION OF THE PREFERRED EMBODIMENTS

The method in accordance with the present invention can be realized with the use of a scanning electron microscope with digital systems of development, for example with microscope S 4700 Hitachi.

The object to be measured is introduced into a chamber of the microscope, and its positioning of the microscope is performed as explained hereinabove, then focusing of the image is performed, and also memorization of the two-dimensional set of video signal in the memory of the computer. A scale of magnification of the microscope must be preliminarily determined with the accuracy of tens and hundreds of percentage points.

Before the beginning of the measurements, it is necessary to determine a set of parameters of the model, and their numerical values, or in other words geometric characteristics of the object or measurement, such as a chemical composition of the object to be measured and of surroundings of the same, a depth of the shape, an inclination of side walls, the presence and height of shaped formations located close to it, the distance to them. Moreover, also characteristics of the microscope must be set, such as the accelerating voltage, resolution, magnification.

As explained herein above, determination of the approximate size of the micro object is performed with the use of known algorithms, such as the Threshold, Line Approximation, Derivative algorithm, etc. and all numerical values of the free parameters of the corresponding algorithm are stored without changes, which are used in the algorithm. For the Threshold algorithm, for example, its parameters are smoothing and threshold.

The determination of the model video signal S_{M}(X) in accordance with the set of the parameters of the model can be used for example in accordance with the method of Monte-Carlo [3], or with the use of analytical models [4]. These calculations must be done since in the model video signal Sₘ(X) the accurate position of the edges of the object to be measured is always known exactly, and therefore its actual size is known as well. The processing of the model video signal in accordance with the selected, inaccurate algorithm leads to an erroneous value of the size Lₘ(X). This error results due to specific peculiarities of the algorithm and influence of free parameters on the results. The main feature of this procedure is that with the unchangeable selected algorithm and unchangeable set of values of free parameters, the value of this error will not change, regardless of whether the experimental video signal Sₒ(X) is measured or its model signal Sₘ(X). In other words with maintaining of all conditions of measurements, the above mentioned error is systematic, and it is introduced additively into the results of the measurements of Sₒ(X) and S_{M}(X).

When the micro object to be measured is a shaped strip, whose width must be determined from all sides and accurately it is necessary to use a certain processing, such as statistic processing with the use of an average size and dispersion. In this case a multiple measurements of a width are performed on different locations, and the results of the individual measurements are averaged.

With a sufficient statistical processing, particular with measurements along all lines of the frame or several frames, it is possible to determine important characteristics of strip-shaped objects such as a line edge roughness and a line width roughness.

It will be understood that each of the elements described above, or two or more together, may also find a useful application in other types of constructions differing from the types described above.

While the invention has been illustrated and described as embodied in a method of determining micro- and nano-sizes in scanning electron microscope, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### REFERENCES

1. A. V. Nikitin, A. Sicignano, D. Yeremin, et al “Accuracy in CD-SEM metrology”, Proc. SPIE Vol. 5038, p. 651-662, Metrology, Inspection and Process Control for Microlithography XVII, June 2003.
2. A. Sicignano, A. Nikitin, D. Yeremin, T. Goldburt, B. Tracy “A novel and robust method for the accurate magnification characterization and calibration of out-of-fab-SEM cluster tools,” Proc. SPIE Vol. 5375, p. 1069-1080, Metrology, Inspection, and Process Control for Microlithography XVIII; May 2004.
3. L. Reimer, “Scanning Electron Microscopy”. Springer Series in Optical Sciences. Vol. 45. Springer-Verlag. Berlin, Heidelberg, New York, Tokio. 1985, pp. 113-116.
4. A. Nikitin, A. Sicignano, D. Yeremin, et al “Defining the role of SEM metrology for advanced process control” Proc. SPIE Vol. 6152, p. 1146-1152, Metrology, Inspection, and Process Control for microlithography XX; March 2006.

1. A method of determining sizes of micro and nano objects in a scanning electron microscope, comprising the steps of obtaining an experimental video signal of an object in a scanning electron microscope; determining a size of an object from the obtained experimental video signal; calculating a model video signal based on the size of an object obtained from the experimental video signal and other properties of the object in the scanning electron microscope; determining a size of the object from the model video signal; determining a correction based on a difference between the size of the object obtained from the experimental video signal and the size of the object obtained from the model video signal; and using the correction to determine a corrected size of the object from the size of the object determined from the experimental video signal and the thusly determined correction.

2. A method as defined in claim 1, wherein the determining the size of an object based on the experimental video signal includes orienting the object in the electron microscope so that a selected direction of measurements coincides with a direction of scanning along lines and frames, obtaining a scanning electron microscope image of the micro object in a digital measuring microscope and storing it in a memory of a computer as a two dimensional set of values S depending on coordinates X and Y in a plane of image-S (X, Y), selecting from the stored two-dimensional set of values S (X, Y) a one-dimensional set S(X) reflecting a distribution of the video signal S along the selected direction of measurements; and determining an approximate size of micro object along said direction X:L₀(X) with the use of a known algorithm.

3. A method as defined in claim 1, wherein said determining a model video signal S_{M}(X) includes using parameters selected from the group consisting of characteristics of an object including coefficients of secondary electron emission for the object and surroundings of the same, angles of inclination of left and right side walls, presence of neighboring shaped details at a left side and at a right side from the object as well as their height and a distance to them, and calculating an approximate size of the micro object L₀(X), as well as characteristic of the scanning electron microscope including accelerating voltage, resolution or diameter of a beam of primary electrons, a scale of magnification or a distance between neighboring pixels for microscopes with a digital scanning.

4. A method as defined in claim 1, wherein said determining size of an object from the model video signal includes determining the size Lₘ(X) of the object from the model video signal with the use of an algorithm which is used for determining said approximate size of the micro object based on the experimental video signal.

5. A method as defined in claim 1, wherein said determining a corrected size of the micro object includes determining based on a formula L=L₀(X)−Δ, wherein Δ=L₀(X)−Lₘ(X).

6. A method as defined in claim 2; and further comprising repeating said selection of the one-dimensional set, said determination of an approximate size of the micro objects, and said correction for a plurality of lines; and subjecting thusly obtained results to a statistical processing with determination of an average size and dispersion.
